(19) United States
(12) Patent Application Publication
(10) Pub. No.: US 2025/0154664 A1
(43) Pub. Date: May 15, 2025

(54) ALKALINE REACTION RINSE FOR DECORATIVE AUTOPHORETIC COATINGS

(71) Applicant: Henkel AG & Co. KGaA, Duesseldorf (DE)

(72) Inventors: Jerome Alexander Moebius, Kaarst (DE); Ulrich Dawidowski, Wildberg (DE)

(21) Appl. No.: 19/024,281

(22) Filed: Jan. 16, 2025

Related U.S. Application Data
(63) Continuation of application No. PCT/EP2023/066049, filed on Jun. 15, 2023.

(30) Foreign Application Priority Data
Jul. 18, 2022 (EP) 22185367.4

(51) Int. Cl. C23G 1/19

(52) U.S. Cl. CPC C23G 1/19

(57) ABSTRACT

The present invention is directed to an aqueous rinse composition having a pH of from 8 to 12 which is obtained by forming a mixture comprising: i) at least one inorganic base; ii) at least one water soluble compound according to general formula (IIA) or a water soluble salt thereof, and/or at least one water soluble compound according to general formula (IIB) or a water-soluble salt thereof; iii) at least one water-soluble polyphosphonic acid or a water-soluble salt thereof according to general formula (III); and, iv) water.

### FIELD OF THE INVENTION

The present invention is directed to an aqueous rinse composition which is used to treat an autodeposited coating on an active metal substrate. More particularly, the present invention is directed to an aqueous rinse composition having a pH of from 8 to 12 which is used to treat an uncured, autodeposited coating on a ferrous metallic substrate.

### BACKGROUND TO THE INVENTION

Autodeposition has been in commercial use on ferrous metallic substrates, such as steel, for more than thirty years and is now well established. The process of autodeposition is often contrasted with electrodeposition: although each said process can produce adherent films on a substrate with similar performance characteristics, the dispersions used in the processes and the mechanisms by which films are deposited are distinctly different. Electrodeposition requires that the metallic or other articles to be coated are connected to a source of direct electrical current for coating to occur: no such external electric current is used in autodeposition, which presents the advantage of a simpler and often less expensive operation and one which further enables the edges and cavities of target substrates to be coated more effectively than with processes which require the application of a voltage.

Autodeposition compositions are conventionally mildly acidic aqueous solutions, suspensions, emulsions or dispersions of resin or polymer. The compositions are customarily disposed in a bath wherein, in the absence of contact with an active metal, the compositions are stable against precipitation or flocculation of the resin or polymer. However, when substrates having an active metal surface are inserted into the bath, those surfaces become coated with an adherent resin or polymer film. For completeness, the term “active metal” is herein defined as a metal that spontaneously begins to dissolve at a substantial rate when introduced into the autodeposition composition. For active ferrous metallic substrates more specifically, the mildly acidic bath reacts with the ferrous substrate to yield positively charged iron ions at the surface of the substrate; these cations react with the negatively-charged latex particles in the bath to form a deposit on the surface of the steel. The deposited wet film is adherent, yet porous, so that acid and iron ions can continue to diffuse and form additional coating. Since this process is diffusion controlled, coverage is quite uniform across the workpiece. The film increases in thickness the longer the metal remains in the bath but eventually, the wet film solids compact to the point where ionic diffusion can no longer occur and the reaction stops.

Upon withdrawal from the coating bath, the adhered films are typically thermally cured. The peak metal temperature (PMT) characterizes the thermal curing process. Higher peak metal temperatures of greater than 200° C. can provide cured coatings having advantageous chemical and thermal resistance but there is obviously a concomitant trade-off with the consumption of energy required to attain these high temperatures. Conversely, compositions which are cured at low peak metal temperatures—such as 130° C. or less—may be characterized by poor heat stability, poor storage stability, poor corrosion resistance and poor chemical resistance.

Instructive disclosures on autodeposition may be found in inter alia: U.S. Pat. Nos. 3,063,877; 3,585,084; 3,592,699; and, EP 0624182A1 (Henkel Corporation). Further, illustrative epoxy resin-based autodeposition coating systems are described in U.S. Pat. Nos. 4,180,603; 4,289,826; 5,500,460; 7,388,044; US Patent Application Publication No. 2003/0068498 A1 (Weller et al.); US Patent Application Publication No. 2018/0304306 A1; and, International Patent Application Publication No. WO 00/71337.

Faced with the need to optimize the corrosion resistance, functionality and/or appearance of autodeposited films, authors have developed three main strategies: i) the chemical pretreatment of the substrate surface prior to forming the coating films; (ii) the purposive selection of particular resins to form the coating films; and, (iii) the chemical post-treatment of the uncured coating film. The present disclosure concerns the last of these strategies.

US2002/102356A1 (Agarwal et al.) discloses a method of improving the corrosion resistance of a metallic surface having a cured autodeposited coating adhered thereto, said method comprising contacting an uncured autodeposited coating present on said metallic surface with an acidic aqueous rinse comprising amounts of at least one source of metal cations selected from the group consisting of Group IIA or Group IIB metal cations and at least one phosphate source.

CA 2,199,983A1 (Henkel Corporation) discloses a process of providing a metal substrate with a protective coating containing an organic binder, said process comprising steps of: (a) contacting the metal substrate with a liquid autodeposition composition for a sufficient time to form on the metal substrate surface a wet adherent film including organic binder deposited from the autodeposition composition: (b) separating the substrate bearing the wet adherent film formed in step (b) from further contact with the autodeposition composition and contacting the wet adherent film with an aqueous liquid rinse solution comprising water and anions that consist of: (i) at least four fluorine atoms and (ii) at least one atom of an element selected from the group consisting of titanium, zirconium, hafnium, silicon, and boron and, optionally, (iii) one or more oxygen atoms; and (C) separating the substrate bearing the wet adherent film as modified by the contacting of step (B) from the aqueous liquid rinse solution used in step (B) and subsequently drying the wet film into place on the substrate to produce a dry film.

U.S. Pat. No. 5,248,525 A (Siebert) discloses a process for forming an autodeposited organic coating on the metallic parts of the surface of an object, said process comprising steps of: i) contacting the metallic surface to be coated with a liquid autodepositing composition to produce an uncured intermediate coating thereon; ii) contacting the uncured intermediate coating, before drying it, with an aqueous solution having a pH between about 7 and about 11 and comprising from about 0.05 to about 5 weight percent of anions of multifunctional organic acids selected from the group consisting of 1,1-diphosphonic acids, citric acid, tartaric acid, and oxalic acid; and, iii) drying said uncured intermediate coating to produce the final autodeposited organic coating.

When a coated surface is removed from an autodeposition bath and water rinsed, the coating is still permeable: this permeability is considered to be caused by iron which is unbound to the latex particles within the autodeposition coating. Most of the aforementioned chemical rinses have the purpose of either removing or precipitating that iron to thereby seal the coating film. However, these processes may not be wholly efficient and residual un-complexed iron—in particular un-complexed Fe³⁺—in the coating film deleteriously impacts the color and appearance of the coating when it is cured. Such discoloration will be evident when the coating film is to be overcoated with a clear coat or lightly colored coat. The person of ordinary skill in the art will recognize that overcoating with a colored coat might mitigate the discoloration caused by the presence of iron but this may not be appropriate in many applications.

There is therefore considered to be a need to provide a novel rinse composition which can efficiently remove un-complexed iron from autodeposition coatings on ferrous metallic substrates without compromising the stability of the uncured coating films and the adhesion and corrosion resistance of the cured films obtained therefrom.

### SUMMARY OF THE INVENTION

In accordance with a first aspect of the invention there is provided an aqueous rinse composition having a pH of from 8 to 12 which is obtained by forming a mixture comprising:
i) at least one inorganic base;
ii) at least one water soluble compound according to general formula (IIA) or a water soluble salt thereof.

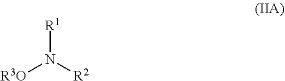

wherein: R¹, R² and R³ are the same or different and are independently selected from H or C₁-C₆ alkyl; and/or
at least one water soluble compound according to general formula (IIB) or a water-soluble salt thereof:

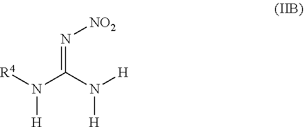

wherein: R⁴ is selected from H or C₁-C₆ alkyl;
iii) at least one water-soluble polyphosphonic acid or a water-soluble salt thereof,
wherein said polyphosphonic acid has the general formula (III):

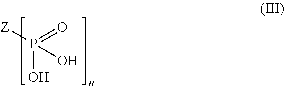

in which: n is at least 2; and,
   Z is a connecting organic moiety having an effective valency of n,
      further wherein said polyphosphonic acid is characterized in that at least two phosphonic groups are separated by an alkylene bridge having 1 or 2 carbon atoms (C₁-C₂ alkylene); and,
iv) water.

In an important embodiment, the aqueous rinse composition has a pH of from 9 to 11 and is obtained by forming a mixture comprising, based on the total weight of the composition:
from 5 to 20 wt. %, preferably from 5 to 15 wt. % and more preferably from 5 to 10 wt. % of i) said at least one inorganic base;
from 10 to 50 wt. %, preferably from 15 to 40 wt. % and more preferably from 20 to 40 wt. % of part ii);
from 5 to 30 wt. %, preferably from 5 to 15 wt. % and more preferably from 10 to 15 wt. % of iii) said at least one water-soluble polyphosphonic acid of general formula (III) or a water-soluble salt thereof; and,
from 30 to 80 wt. %, preferably from 40 to 70 wt. % and more preferably from 40 to 60 wt. % of iv) water.

In an illustrative embodiment, the aqueous rinse composition has a pH of from 9 to 11 and is obtained by forming a mixture comprising, based on the total weight of the composition:
from 5 to 20 wt. %, preferably from 5 to 15 wt. % and more preferably from 5 to 10 wt. % of i) said at least one inorganic base;
from 10 to 50 wt. %, preferably from 15 to 40 wt. % and more preferably from 20 to 40 wt. % of ii) said at least one substituted amine compound according to formula (IIA) or a water-soluble salt thereof;
from 5 to 30 wt. %, preferably from 5 to 15 wt. % and more preferably from 10 to 15 wt. % of iii) said at least one water-soluble polyphosphonic acid of general formula (III) or a water-soluble salt thereof; and,
from 30 to 80 wt. %, preferably from 40 to 70 wt. % and more preferably from 40 to 60 wt. % of iv) water.

It will be evident to the skilled artisan that in certain embodiments, a neutralization reaction will occur within the mixture between the recited base (part i)) and any free acid added in part iii). The molarity of the added parts of the mixture must however be selected to meet the alkaline pH condition of the aqueous rinse composition.

Without intention to be bound by theory, it is considered that at the recited pH, the part ii) compound(s)—hydroxylamine, substituted hydroxylamine, nitroguanidine, substituted nitroguanidine and mixtures thereof—act to reduce Fe(III) ions present in an autodeposited film on a ferrous metallic substrate: the obtained Fe(II) ions may then be complexed by the polyphosphonate anions present in the aqueous rinse composition. The formed complex is stable and can be washed out of the film to achieve the desired appearance.

It is preferred that i) said at least one inorganic base of the mixture is selected from the group consisting of: sodium carbonate; potassium carbonate; sodium hydroxide; potassium hydroxide; sodium metasilicate; and, potassium metasilicate. It is particularly preferred that part i) of the mixture comprises or consists of sodium hydroxide.

Independently of or additional to these statements of preference for the base, it is preferred that part ii) of the mixture consists of at least one compound selected from the group consisting of: hydroxylamine (NH₂—OH); N-methylhydroxylamine; N,N-dimethylhydroxylamine; N-isopropyl hydroxylamine; N,N-diethylhydroxylamine; nitroguanidine; 1-methyl-3-nitroguanidine; and, 1-ethyl-3-nitroguanidine. It is particularly preferred that part ii) comprises or consists of either hydroxylamine (NH₂—OH), nitroguanidine or a mixture thereof.

Again independently of or additional to the statements of preference for parts i) and ii) of the mixture, it is preferred that iii) said at least one water-soluble polyphosphonic acid is selected from the group consisting of: aminotris(methylene phosphonic acid) (ATMP); 1-hydroxyethylidene-1,1-diphosphonic acid (HEDP); hexamethylene diamine tetra(methylene phosphonic acid) (HDTMP); diethylenetriamine penta(methylene acid); phosphonic and, diethylenetriamine penta(methylenephosphonic acid (DTPMP). It is particularly preferred that part iii) comprises or consists of 1-hydroxyethylidene-1,1-diphosphonic acid (HEDP).

In accordance with a second aspect of the invention, there is provided the use of the aqueous rinse composition as defined hereinabove and in the appended claims in the rinsing of a coating film applied to a ferrous metallic substrate.

The present invention also provides a method of providing a ferrous metallic substrate with a protective coating containing an organic binder, said method comprising:
contacting said ferrous metallic substrate with a liquid autodeposition composition for sufficient time to form on at least one surface of said substrate an adherent film coating including a curable organic binder deposited from said autodeposition composition;
separating the coated ferrous metallic substrate from the liquid autodeposition composition;
subjecting the adherent film coating to a rinsing stage, wherein said rinsing stage comprises at least one rinsing step using the aqueous rinsing composition as defined hereinabove and in the appended claims; and,
curing the organic binder included in the rinsed adherent film coating.
   The rinsing stage may be constituted by a single rinsing step or by a plurality of rinsing steps. However, whilst more than one rinsing liquid may be employed in a multi-step process, it is imperative that at least one rinsing step using the aqueous rinsing composition of the present invention is performed. It is particularly preferred for the final step of a multi-step rinsing stage to use the aqueous rinsing composition of the present invention.

In an important embodiment, the method of providing a ferrous metallic substrate with a protective coating containing an organic binder comprises the steps of:
pre-treating the ferrous metallic substrate to remove foreign matter from the surfaces thereof;
contacting said ferrous metallic substrate with a liquid autodeposition composition for sufficient time to form on at least one surface of said substrate an adherent film coating including a curable organic binder deposited from said autodeposition composition;
separating the coated ferrous metallic substrate from the liquid autodeposition composition;
subjecting the adherent film coating to a rinsing stage having a plurality of rinsing steps, wherein said rinsing stage comprises at least one rinsing step using the aqueous rinsing composition as defined hereinabove and in the appended claims and wherein said rinsing stage is further characterized in that a step of rinsing using said defined aqueous rinsing composition constitutes the terminal step of said stage; and,
curing the organic binder included in the rinsed adherent film coating.

A final aspect of the present invention provides a ferrous metallic substrate obtained in accordance with the method defined coating method defined hereinabove and in the appended claims.

### DEFINITIONS

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps. If used, the phrase “consisting of” is closed, and excludes all additional elements. Further, the phrase “consisting essentially of” excludes additional material elements, but allows the inclusions of non-material elements that do not substantially change the nature of the invention.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

The words “preferable”, “preferred”, “preferably”, “particularly” and “desirably” and synonyms thereof are used frequently herein to refer to embodiments of the disclosure that may afford particular benefits, under certain circumstances. However, the recitation of one or more preferable, preferred, particular or desirable embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

The phrase “and/or” as used herein, should be understood to mean “either or both” of the elements so conjoined, i.e., elements that are conjunctively present in some cases and disjunctively present in other cases. The expressions “at least one” and “one or more” are also intended to be both conjunctive and disjunctive in operation herein.

With respect to a given part of the recited mixture or composition, the terms “comprising at least one of”, “consisting of at least one of” followed by a listing of items does not imply that each item in the list is required. Rather, it means that one or more of the items listed may comprise the part specified. For example, if it is said part “A comprises at least one of compounds a, b and c”, it is meant that: (i) A may comprise a; (ii) A may comprise b; (iii) A may comprise c; (iv) A may comprise a and b; (v) A may comprise a and c; (vi) A may comprise b and c; or, (vii) A may comprise a, b and c. Analogously, the statement that part “A comprises at least one compound selected from the group consisting of a, b and c” means that: (i) A may comprise a; (ii) A may comprise b; (iii) A may comprise c; (iv) A may comprise a and b; (v) A may comprise a and c; (vi) A may comprise b and c; or, (vii) A may comprise a, b and c.

Where a reference is made to a Periodic Table of Elements and the groups thereof, this is intended to denote that Table illustrated at https://iupac.org/what-we-do/periodic-table-of-elements/.

As used herein, room temperature is 23° C. plus or minus 2° C.

As used herein, number average molecular weight (Mn) and weight average molecular weight (Mw) are determined by gel permeation chromatography (GPC) with tetrahydrofuran (THF) as the eluent in accordance with DIN 55672-1:2007-08. The term polydispersity (PD) is derived from Mw and Mn and is calculated as (Mw/Mn).

As used herein, by “d₅₀ particle size” is meant that the particle size distribution is such that at least 50% of the particles by weight have a particle size diameter of less than the specified value. Unless otherwise stated, that particle size is determined by laser diffraction.

The term “aqueous rinse composition” as used herein refers to that composition which actually contacts the metallic substrate. As is known in the art, such contacting can occur in a so-called “bath” which is shaped, sized and disposed to enable at least part of the substrate to be immersed therein. The bath should moreover be sized to allow for movement of the aqueous rinse composition around and throughout the loaded substrate, which movement can be further enhanced with recirculation and/or ultrasonics. The pH of the composition within the bath, the temperature of the bath, and contact time of the substrate are result effective variables which should be monitored either manually or automatically, whenever possible.

As used herein, “pH” refers to a measure of the effective concentration of hydrogen ions in a solution: pH=−log[H⁺]. The pH may be measured by a standard pH meter comprising a glass electrode connected to an electronic meter; the pH meter is calibrated using aqueous standard pH buffers.

As used herein, the term “alloy” refers to a substance composed of two or more metals or of a metal and a non-metal which have been intimately united, usually by being fused together and dissolved in each other when molten. The term “X alloy” therefore denotes an alloy of which the metal X is the majority constituent component and wherein X will generally comprise at least 40 wt. %—more typically at least 50 wt. % or at least 60 wt. %—of the alloy, on a metals basis.

As used herein, “C₁-Cₙ alkyl” group refers to a monovalent group that contains 1 to n carbons atoms, that is a radical of an alkane and includes straight-chain and branched organic groups. As such, a “C₁-C₁₈ alkyl” group refers to a monovalent group that contains from 1 to 18 carbons atoms, that is a radical of an alkane and includes straight-chain and branched organic groups. Examples of alkyl groups include, but are not limited to: methyl; ethyl; propyl; isopropyl; n-butyl; isobutyl; sec-butyl; tert-butyl; n-pentyl; n-hexyl; n-heptyl; and, 2-ethylhexyl. In the present invention, such alkyl groups may be unsubstituted or may be substituted with one or more halogen. Where applicable for a given moiety (R), a tolerance for one or more non-halogen substituents within an alkyl group will be noted in the specification.

The term “alkylene” as used herein, is defined as a saturated, divalent hydrocarbon radical. In general in the present disclosure, such alkylene groups may be unsubstituted or may be substituted with one or more halogen.

The term “base” as used herein refers to a species: which is capable of abstracting a proton in either a polar or non-polar solvent; or, which is capable of donating a hydroxide anion (OH⁻).

The term “amine” is used in accordance with its ordinary meaning in the art and broadly refers to a compound containing a nitrogen atom with a lone electron pair.

Viscosities of the compositions are herein determined at standard conditions of 25° C. and 50% Relative Humidity (RH). The viscosity is measured herein using a Physica Rheometer MCR 300 Measuring system characterized by a PP 20 spindle and a measuring gap of 0.2 mm.

The present compositions may be defined herein as being “substantially free” of certain compounds, elements, ions or other like components. The term “substantially free” is intended to mean that the compound, element, ion or other like component is not deliberately added to the composition and is present, at most, in only trace amounts which will have no (adverse) effect on the desired properties of the coating. An exemplary trace amount is less than 1000 ppm by weight of the composition. The term “substantially free” encompasses the term “free”, the latter term indicating those embodiments where the specified compound, element, ion, or other like component is completely absent from the composition or is not present in any amount measurable by techniques generally used in the art.

### DETAILED DESCRIPTION OF THE INVENTION

### i) Base

In forming the aqueous rinse compositions of the present invention, the prepared mixture comprises at least one inorganic base. Said inorganic base(s) should be included in an amount such that the aqueous rinse composition has a pH of from 8 to 12, in particular from 9 to 11. Within the constraints of this pH characterization, the mixture may be further characterized by comprising, based on the weight of the composition, from 5 to 20 wt. %, preferably 5 to 15 wt. % of i) said at least one inorganic base.

In an embodiment, the mixture may comprise ammonia (NH₃) as a base, either independently or in combination with one or more other inorganic bases. For completeness, the constituent weight of ammonia included in the mixture is to be calculated on the basis of NH₃. Unreacted ammonia will be present in the aqueous compositions of the present invention as an ammonia solution NH₃(aq.) which encompasses weakly basic solutions of ammonia in water which may referred to in the art as ammonium hydroxide, ammonia water, ammonia liquor, aqua ammonia, aqueous ammonia, or simply ammonia. While the term “ammonium hydroxide” suggests a base with the composition [NH₄⁺][OH³¹ ], it is virtually impossible to isolate samples of NH₄OH, insomuch as these ions do not comprise a significant fraction of the total amount of ammonia in an ammonia solution, except in the case of extremely dilute ammonia solutions.

In a further embodiment, which is not intended to be mutually exclusive of that given above, the mixture may comprise at least one inorganic base having the general formula (I):

(Z₁^{x-})m(Z₂^{y+})ₙ (I),

wherein: Z₂ denotes a metal selected from Groups 1 to 13 of the Periodic Table of the Elements;
Z₁^{x-} denotes an anion selected from the group consisting of CO₃²⁻, OH⁻, HCO₃²⁻, SiO₃⁻, HPO₄²⁻, PO₄³⁻ and B₄O₇²⁻ ions;
   x is 1, 2 or 3;
   y is 1, 2, 3 or 4;
   m and n denote, independently of each other, 1, 2, 3, or 4; and,
   n*y=m*x.
      As regards said Formula (I), it is preferred that: Z₂ denotes a metal from Groups 1 and 2 of the Periodic Table of the Elements; Z₁^{x-} denotes an anion selected from the group consisting of: CO₃²⁻, OH⁻ and SiO₃⁻ ions; x is 1; y denotes 1 or 2; m and n independently of one another denote 1 or 2; and, n*y=m*x.

Exemplary but non-limiting inorganic bases, which may be present alone or in combination, include: sodium carbonate; potassium carbonate; sodium hydroxide; potassium hydroxide; sodium metasilicate; and, potassium metasilicate. A preference may be mentioned for the use of sodium hydroxide.

### ii) Water Soluble Hydroxylamine, Substituted Hydroxylamine, Nitroguanidine or Substituted Nitroguanidine

The mixture preferably comprises from 10 to 50 wt. %, for example from 15 to 40 wt. % or from 20 to 40 wt. %, based on the weight of the composition, of part ii), said part consisting of:
ii) a) at least one substituted amine compound according to formula (IIA) or a water-soluble salt thereof

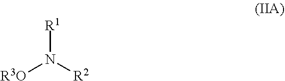

wherein: R¹, R² and R³ may be the same or different and are independently selected from H or C₁-C₆ alkyl; and/or
ii) b) at least one water soluble compound according to general formula (IIB) or a water-soluble salt thereof

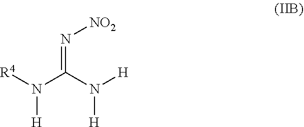

wherein: R⁴ is selected from H or C₁-C₆ alkyl.
   In an embodiment, said part ii) consists of at least one substituted amine compound according to formula (IIA) or a water-soluble salt thereof.

Exemplary salts of compounds of general formula (IIA) include but are not limited to: hydrochloride (NR¹R²(OR³)·HCl); sulphate; and, phosphate salts. As regards formula (IIA), it is preferred that R¹, R² and R³ are independently selected from H or C₁-C₄ alkyl. In an embodiment, R³ is H and R¹ and R² are independently selected from H or C₁-C₄ alkyl. In a particularly preferred embodiment R¹, R² and R³ are each H.

Exemplary compounds in accordance with formula (IIA), which may be added alone or in combination to form the mixture from which the aqueous rinse composition is obtained include: hydroxylamine (NH₂—OH); N-methylhydroxylamine; N,N-dimethylhydroxylamine; N-isopropyl hydroxylamine; and, N,N-diethylhydroxylamine. A particular preference is noted for the presence of hydroxylamine in the aqueous rinse compositions.

As regards formula (IIB), it is preferred that R⁴ is selected from H or C₁-C₄alkyl. In an embodiment, R⁴ is selected from H or C₁-C₂ alkyl. In a particularly preferred embodiment R⁴ is H or methyl.

Exemplary compounds in accordance with formula (IIB), which may be added alone or in combination to form the mixture from which the aqueous rinse composition is obtained include: nitroguanidine; 1-methyl-3-nitroguanidine; and, 1-ethyl-3-nitroguanidine.

### iii) Polyphosphonic Acid or Water-Soluble Salt Thereof

A further required component of the mixture of the present invention is iii) at least one water-soluble polyphosphonic acid or a water-soluble salt thereof, wherein said polyphosphonic acid has the general formula (III):

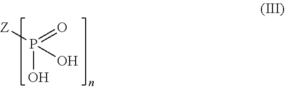

in which:
n is at least 2; and,
Z is a connecting organic moiety having an effective valency of n,
said polyphosphonic acid being characterized in that at least two phosphonic groups are separated by an alkylene bridge having 1 or 2 carbon atoms (C₁-C₂ alkylene).

In particular embodiments, n is an integer from 2 to 5 or, preferably, either 2 or 3. Most desirably, said polyphosphonic acid is selected from a group consisting of: aminotris(methylene phosphonic acid) (ATMP); 1-hydroxyethylidene-1,1-diphosphonic acid (HEDP); hexamethylene diamine tetra(methylene phosphonic acid) (HDTMP); diethylenetriamine penta(methylene phosphonic acid); diethylenetriamine penta(methylenephosphonic acid (DTPMP); and, mixtures thereof. A particular preference for the use of 1-hydroxyethylidene-1,1-diphosphonic acid (HEDP) should be noted.

Suitable water soluble salts of the aforementioned polyphosphonic acids include the sodium, potassium, calcium, magnesium, ammonium, triethanolammonium, diethanolammonium and monoethanolammonium salts.

The polyphosphonic acids or the water soluble salts thereof are preferably included in the mixture in an amount of from 5 to 30 wt. %, for example from 5 to 15 or from 10 to 15 wt. %, based on the weight of the composition.

### Adjunct Ingredients

The aqueous rinse compositions of the present disclosure may further comprise adjuvants and additives that can impart improved properties to these compositions. The adjuvants and additives may, for instance, impart one or more of: reduced drying time; reduced corrosiveness; improved stability; and, longer shelf-life of the compositions.

Such additives and adjuvants might, for instance, include: corrosion inhibitors, such as dialkylthioureas, cupric sulphate and copper sulphate; de-foaming agents; water-miscible co-solvents; sequestrants; surfactants; and, mixtures thereof. As further exemplary corrosion inhibitors mention may be made of the following commercial materials: the Rodine® series, available from JMN Specialties, Inc. and Henkel Corporation; the Dodicor® series, available from Clariant AG; and, the Armohib® series available from Akzo Nobel Surfactants LLC.

The additives and adjuvants may be mixed simultaneously with parts i) to iv) to form the above described mixture and thus may be present during any neutralization reaction which occurs within the mixture. Alternatively, the additives or adjuvants may be added subsequent to the mixing and, where applicable, said neutralization reaction of parts i) to iii). Where the neutralization reaction is exothermic, the formed solution may be permitted to cool prior to the admixture of the additives or adjuvants.

Adjuvants and additives can be used in such combination and proportions as desired, provided they do not adversely affect the nature and essential properties of the composition. While exceptions may exist in some cases, these adjuvants and additives should not in toto comprise more than 5 wt. % of the total weight of the aqueous rinsing composition.

### Exemplary Formulations of the Aqueous Rinse Composition

In a first exemplary embodiment, which embodiment is not intended to be limiting of the present invention, there is provided an aqueous rinse composition having a pH of from 9 to 11, which is obtained by forming a mixture comprising, based on the total weight of the composition:
from 5 to 15 wt. %, preferably from 5 to 10 wt. % of i) at least one inorganic base selected from the group consisting of sodium carbonate, potassium carbonate, sodium hydroxide, potassium hydroxide, sodium metasilicate and potassium metasilicate;
from 15 to 40 wt. %, preferably from 20 to 40 wt. % of ii) at least one compound selected from the group consisting of hydroxylamine (NH₂—OH), N-methylhydroxylamine, N,N-dimethylhydroxylamine, N-isopropyl hydroxylamine, N,N-diethylhydroxylamine, nitroguanidine, 1-methyl-3-nitroguanidine and 1-ethyl-3-nitroguanidine;
from 5 to 15 wt. %, preferably from 10 to 15 wt. % of iii) at least one water-soluble polyphosphonic acid selected from the group consisting of aminotris(methylene phosphonic acid) (ATMP), 1-hydroxyethylidene-1,1-diphosphonic acid (HEDP), (hexamethylene diamine tetra(methylene phosphonic acid) (HDTMP), diethylenetriamine penta(methylene phosphonic acid), and, diethylenetriamine penta(methylenephosphonic acid (DTPMP); and,
from 40 to 70 wt. %, preferably from 40 to 60 wt. % of iv) water.

In a second exemplary embodiment, which embodiment is not intended to be limiting of the present invention, there is provided an aqueous rinse composition having a pH of from 9 to 11, which is obtained by forming a mixture comprising, based on the total weight of the composition:
from 5 to 15 wt. %, preferably from 5 to 10 wt. % of i) at least one inorganic base selected from the group consisting of sodium carbonate, potassium carbonate, sodium hydroxide and potassium hydroxide;
from 15 to 40 wt. %, preferably from 20 to 40 wt. % of ii) at least one of hydroxylamine (NH₂—OH) and nitroguanidine;
from 5 to 15 wt. %, preferably from 10 to 15 wt. % of iii) at least one water-soluble polyphosphonic acid selected from the group consisting of aminotris(methylene phosphonic acid) (ATMP), 1-hydroxyethylidene-1,1-diphosphonic acid (HEDP), hexamethylene diamine tetra(methylene phosphonic acid) (HDTMP), diethylenetriamine penta(methylene phosphonic acid), and, diethylenetriamine penta(methylenephosphonic acid (DTPMP); and,
from 40 to 70 wt. %, preferably from 40 to 60 wt. % of iv) water.

Good results have, in particular, been obtained using an aqueous rinse composition having a pH of from 9 to 11 and which is obtained by forming a mixture comprising, based on the total weight of the composition:
from 5 to 10 wt. % of i) sodium hydroxide;
from 20 to 40 wt. % of ii) hydroxylamine (NH₂—OH);
from 10 to 15 wt. % of iii) 1-hydroxyethylidene-1,1-diphosphonic acid (HEDP; and,
from 40 to 60 wt. % of iv) water.

### Preparation of the Aqueous Compositions

The aqueous compositions are formulated by simple mixing of the stated parts. If necessary, the composition may be prepared well in advance of its application. However, in an interesting alternative embodiment, a concentrated composition may first be obtained by mixing parts i) to iii) with only a fraction of the water that would be present in the composition as applied: the concentrated composition may then be diluted with the remaining water shortly before its use. It is considered that such concentrated compositions may be prepared and stored as either single-package concentrates—that can be converted by dilution with water only—or as multi-part concentrates, two or more of which must be combined and diluted to form a complete working composition according to the invention. Any dilution can be affected simply by the addition of water, in particular deionized and/or demineralized water, under mixing. The composition might equally be prepared within a rinse stream whereby one or more streams of the concentrate(s) is injected into a continuous stream of water.

Without specific intention to limit the amount of water included in the aqueous compositions, it is preferred that said compositions contain from 30 to 80 wt. %, preferably from 40 to 70 wt. % and more preferably from 40 to 60 wt. %, based on the weight of the composition, of water. In an alternative but not mutually exclusive characterization, the aqueous composition may be defined by a viscosity of from 5 to 1000 mPa.s, for instance from 5 to 500 mPa.s, as measured at 25° C. and 50% relative humidity.

### METHODS AND APPLICATIONS

The use of the present aqueous rinse composition will be described with respect to the autodeposition coating of an active ferrous metallic substrate. As will be recognized by the skilled artisan, prior to applying the autodeposition coating to an active ferrous metallic substrate, it is often advisable to pre-treat the relevant surfaces to remove foreign matter there from: this step can, if applicable, facilitate the subsequent adhesion of the compositions thereto. Such treatments are known in the art and can be performed in a single or multi-stage manner constituted by, for instance, the use of one or more of: an etching treatment with an acid suitable for the substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as acetone, carbon tetrachloride or trichloroethylene; and, water rinsing, preferably with deionized or demineralized water. In those instances where a waterborne alkaline degreasing bath is used, any of the degreasing agent remaining on the surface should desirably be removed by rinsing the substrate surface with deionized or demineralized water.

Subsequent to any pre-treatment(s) which may have been applied, the active ferrous metallic substrate is contacted with a liquid autodeposition coating composition containing a curable organic binder, optionally together with one or more autodeposition accelerators, for sufficient time to form on at least one surface of said substrate an adherent film coating including the curable organic binder. Such contacting is conventionally performed in an operating bath as hereinbefore described: such a bath is prepared and the liquid autodeposition composition is applied to the substrate by, without limitation, immersion and dipping. The contact time with the autodeposition coating composition is not critical but should be sufficient to allow the temperature of the ferrous metallic substate to equilibrate with the temperature of the composition in the operating bath: exemplary contact times are from 1 minute to 15 minutes, for instance from 2 to 10 minutes. In an alternative, but not mutually exclusive characterization of this contacting step, the duration of contact between the active metallic surface(s) and the liquid autodeposition coating composition should be sufficient to produce a wet film thickness from 10 to 100 microns, for instance from 10 to 50 microns.

Alternative techniques which may be used to apply the liquid autodeposition coating composition to cither a singular surface or multiple surfaces of a ferrous metallic substrate include but are not limited to: painting; brushing; flow coating; roll coating; wiping; air-atomized spraying; air-assisted spraying; airless spraying; high-volume low-pressure spraying; and, air-assisted airless spraying.

It is noted here, that the present application has particular utility where the liquid autodeposition coating is an aqueous composition comprising dispersed acrylate resins. By way of non-limiting example, EP 0624182A1 (Henkel Corporation) discloses an aqueous autodeposition coating composition having a pH in the range of from 1.6 to 5.0 which comprises: a) a water dispersible or water-soluble organic film forming resin selected from the group consisting of urethane resin, epoxy resin, polyester resin, and a resin comprising a residue of at least one monomer selected form the group consisting of methyl acrylate, ethyl acrylate or butyl acrylate, 2-hydroxy ethyl acrylate, 2-hydroxypropyl acrylate, 2-ethylhexyl acrylate, methyl methacrylate, ethyl methacrylate, n-butyl methacrylate, 2-hydroxyethyl methacrylate, 2-hydroxypropyl methacrylate, glycidyl acrylate, glycidyl methacrylate, acrylamide, methacrylamide, ethylene, styrene, vinyl chloride, vinylidene chloride, vinyl acetate, acrylic acid and methacrylic acid; b) at least one of fluoride ion or fluoride ion and complex fluoride ion; c) additional metal ions of at least one metal selected from the group consisting of zinc, cobalt, manganese, nickel, iron and aluminum; d) at least one of tungstate ion and molybdate ion; and, e) water. As a further important example, US 2003/0068498 A1 (Weller et al.) discloses an autodeposition composition comprising: (a) water; (b) at least one epoxy resin in dispersed form; (c) at least one acrylic resin in dispersed form; and, (d) at least one epoxy curing agent. The disclosures of the unpigmented autodeposition coating compositions (C-L. N and O) of the examples of Table I of EP 0624182A1 and the disclosure of the Example of US 2003/0068498 A1 are specifically incorporated herein by reference.

The active metallic substrate—having a film coating of uncured organic binder thereon—is then separated from the autodeposition coating composition and subjected to a rinsing stage comprising at least one rinsing step using the aqueous rinsing composition of the present invention. For surety, it is noted that the rinsing stage may—if so required to remove absorbed but otherwise unadhered components of the curable film coating—comprise multiple rinse steps and utilize a plurality of distinct rinse agents but at least one rinse step must use the defined aqueous rinsing composition. It is, however, preferred that rinsing with tap water, demineralized water or deionized water not be performed after rinsing with the aqueous composition of the present invention because this may diminish the positive impacts of the composition.

There is no particular intention to limit the method by which the substrate is rinsed: for each rinsing agent independently the substrates may, for instance, be: immersed or dipped in a bath thereof; roll coated with the rinse agent; spray-treated with the rinse agent; treated with a mist of the agent; or, a combination of said treatments may be applied. Good results have been achieved by the immersing the substrate in the aqueous rinse composition of the present invention. Based upon contact time, the total duration of the rinsing stage, whether performed as one or multiple steps, will typically be from 5 to 600 seconds, for instance from 10 to 300 or from 30 to 300 seconds. When using relatively small concentrations of the active compounds in the aqueous rinse composition, contact times will by necessity be much longer than when using a composition containing relatively high concentrations of said compounds.

The, or each, rinsing agent should be maintained at a temperature of from 20 to 100° C., for example from 25 to 75° C. or from 30 to 70° C. during the rinsing treatment. Whilst elevating the temperature of the present aqueous rinsing composition above room temperature will have a concomitant energetic cost, the coating edge coverage is generally improved by increasing the rinse temperature.

Following the rinsing treatment, the organic binder coated onto the ferrous metallic substrate may be cured. Curing may be performed in any known manner but will typically be affected by heating. The selection of the particular curing temperature will depend inter alia upon the type of binder resin, the cross-linking agent and any coalescent used for the autodeposition coating. That aside, the surface temperature of the metallic substrate should be controlled during heating: the peak metal temperature (PMT) need not exceed 300° C and should, more particularly, be in the range from 65 to 200° C, for example from 75 to 150° C.

In toto, the heating of the ferrous metallic substrate may occur for a duration of from 5 to 60 minutes, for instance, from 10 to 50 minutes. That acknowledged, the heating may itself be performed in multiple stages, if desired. For example, in a first stage lasting from 5 to 15 minutes, the coated substrate is heated to a peak temperature of 55° C. to 65° C. to flash off most of the residual water in the coating; and, in a second stage lasting from 15 to 55 minutes, the coated substrate is heated to a peak temperature of from 65 to 300° C., for instance from 75 to 150° C. The peak temperature is attained in preferably no more than 10 minutes after the first heating stage has been completed.

The above-described treatment should yield a cured coating over the ferrous metallic substrate, said coating preferably having a weight of from 1 to 50 g/m², preferably from 1 to 40 g/m² or from 5 to 40 g/m².

There is no intention to limit the base ferrous metallic substrate to which the aforementioned coating process may be applied. As such, suitable base ferrous metallic substrates may include but not be limited to: iron; alloys of iron with an element selected from boron, carbon, cerium, chromium, cobalt, copper, manganese, molybdenum, nickel, silicon, titanium, uranium or vanadium; Elinvar (iron-nickel-chromium); Fernico (iron-nickel-cobalt); Kovar (iron-nickel-cobalt); Kanthal (iron-chromium-aluminum); and, steel. Illustrative steel substrates include: cold rolled steel; hot rolled steel; steel coated with zinc metal, zinc compounds or zinc alloys, such as electrogalvanized steel; hot-dipped galvanized steel; galvannealed steel; and steel plated with zinc alloy. And particular mention may be made of the following ferrous metallic substrates comprising or consisting of steel: galvanized and galvanneal steel meeting the requirements of ASTM Designation A653; GALVALUME®, a 55% A1/43.4% Zn/1.6% Si alloy coated sheet steel available from Bethlehem Steel Corporation; and, GALFAN®, a 5% A1/95% Zn alloy coated sheet steel available from Weirton Steel Corporation.

The initial form of the substrate to which the afore-described treatment process is applied also need not be limited. Whilst more complex shapes and pre-fabricated forms are certainly not precluded, conventional stock forms in which the ferrous metallic substrates may be provided include: sheets; plates; cuboids; spheres; annuli; solid cylinders; tubes; and, wires.

Various features and embodiments of the disclosure are described in the following example, which is intended to be representative and not limiting.

1. An aqueous rinse composition having a pH of from 8 to 12 which is obtained by forming a mixture comprising:
i) at least one inorganic base;
ii) at least one water soluble compound according to general formula (IIA) or a water-soluble salt thereof: 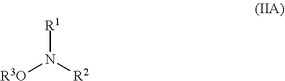
wherein: R¹, R² and R³ are independently selected from H or C₁-C₆ alkyl;
and/or
at least one water soluble compound according to general formula (IIB) or a water-soluble salt thereof: 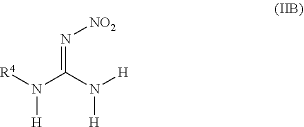
wherein: R⁴ is selected from H or C₁-C₆ alkyl;
iii) at least one water-soluble polyphosphonic acid or a water-soluble salt thereof, wherein said polyphosphonic acid has the general formula (III): 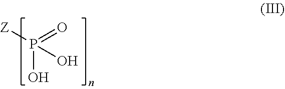
in which: n is at least 2; and,
Z is a connecting organic moiety having an effective valency of n, further wherein said polyphosphonic acid is characterized in that at least two phosphonic groups are separated by an alkylene bridge having 1 or 2 carbon atoms (C₁-C₂ alkylene); and,
iv) water.

2. The aqueous rinse composition according to claim 1 having a pH of from 9 to 11, which is obtained by forming a mixture comprising, based on total weight of the composition:
from 5 to 20 wt. % of i) said at least one inorganic base;
from 10 to 50 wt. % of ii) said at least one compound according to general formula (IIA) or a water-soluble salt thereof and/or said at least one compound according to general formula (IIB) or a water-soluble salt thereof;
from 5 to 30 wt. % of iii) said at least one water-soluble polyphosphonic acid of general formula (III) or a water-soluble salt thereof; and,
from 30 to 80 wt. % of iv) water.

3. The aqueous rinse composition according to claim 2 having a pH of from 9 to 11, which is obtained by forming a mixture comprising, based on the total weight of the composition:
from 5 to 15 wt. % of i) said at least one inorganic base;
from 15 to 40 wt. % of ii) said at least one compound according to general formula (IIA) or a water-soluble salt thereof and/or said at least one compound according to general formula (IIB) or a water-soluble salt thereof;
from 5 to 15 wt. % of iii) said at least one water-soluble polyphosphonic acid of general formula (III) or a water-soluble salt thereof; and,
from 40 to 70 wt. % of iv) water.

4. The aqueous rinse composition according to claim 1, wherein i) said at least one inorganic base is selected from the group consisting of: sodium carbonate; potassium carbonate; sodium hydroxide; potassium hydroxide; sodium metasilicate; and, potassium metasilicate.

5. The aqueous rinse composition according to claim 4, wherein part i) consists of sodium hydroxide.

6. The aqueous rinse composition according to claim 1, wherein:
R¹, R² and R³ in general formula (IIA) are independently selected from H or C₁-C₄ alkyl; and,
R⁴ in general formula (IIB) is H or C₁-C₂ alkyl.

7. The aqueous rinse composition according to claim 6, wherein part ii) of the mixture consists of at least one compound selected from the group consisting of: hydroxylamine (NH₂—OH); N-methylhydroxylamine; N,N-dimethylhydroxylamine; N-isopropyl hydroxylamine; N,N-diethylhydroxylamine; nitroguanidine; 1-methyl-3-nitroguanidine; and, 1-ethyl-3-nitroguanidine.

8. The aqueous rinse composition according to claim 7, wherein part ii) consists of either hydroxylamine (NH₂—OH), nitroguanidine or a mixture thereof.

9. The aqueous rinse composition according to claim 1, wherein n in general formula (III) is an integer from 2 to 5.

10. The aqueous rinse composition according to claim 9 having a pH of from 9 to 11, which is obtained by forming a mixture comprising, based on total weight of the composition:
from 5 to 10 wt. % of i) said at least one inorganic base;
from 20 to 40 wt. % of ii) said at least one compound according to general formula (IIA) or a water-soluble salt thereof and/or said at least one compound according to general formula (IIB) or a water-soluble salt thereof;
from 10 to 15 wt. % of iii) said at least one water-soluble polyphosphonic acid of general formula (III) or a water-soluble salt thereof; and,
from 40 to 60 wt. % of iv) water.

11. The aqueous rinse composition according to claim 1, wherein iii) said at least one water-soluble polyphosphonic acid is selected from the group consisting of: aminotris(methylene phosphonic acid) (ATMP); 1-hydroxyethylidene-1,1-diphosphonic acid (HEDP); hexamethylene diamine tetra(methylene phosphonic acid) (HDTMP); diethylenetriamine penta(methylene phosphonic acid); and, diethylenetriamine penta(methylenephosphonic acid (DTPMP).

12. The aqueous rinse composition according to claim 11, wherein part iii) consists of 1-hydroxyethylidene-1,1-diphosphonic acid (HEDP).

13. The method of reducing discoloration of autodeposition coatings on ferrous metallic substrates by rinsing as—deposited uncured adherent autodeposition film with the aqueous rinse composition according to claim 1.

14. A method of providing a ferrous metallic substrate with a protective coating containing an organic binder, said method comprising:
contacting said ferrous metallic substrate with a liquid autodeposition composition for sufficient time to form on at least one surface of said substrate an adherent film coating including a curable organic binder deposited from said autodeposition composition;
separating the coated ferrous metallic substrate from the liquid autodeposition composition;
subjecting the adherent film coating to a rinsing stage, wherein said rinsing stage comprises at least one rinsing step using the aqueous rinsing composition according to claim 1, as the terminal step of said rinsing stage and,
curing the organic binder included in the rinsed adherent film coating.

15. The method according to claim 14 further comprising the step of:
pre-treating the ferrous metallic substrate to remove foreign matter from the surfaces thereof prior to the contacting step;
wherein the subjecting the adherent film coating to a rinsing stage step comprises a plurality of rinsing steps.

16. A ferrous metallic substrate obtained in accordance with the method of claim 15.
